(19) United States
(12) Patent Application Publication
(10) Pub. No.: US 2004/0015836 A1
(43) Pub. Date: Jan. 22, 2004

(54) Production of redundant computer program modules

(76) Inventor: Michael Layes, Nussbaumen (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/122,232

(22) Filed: Apr. 16, 2002

(30) Foreign Application Priority Data
Apr. 19, 2001 (EP) 01810384.6

(51) Int. Cl. G06F 9/44

(52) U.S. Cl. 717/106

(57) ABSTRACT

According to the invention, n redundant computer program modules are automatically produced for n redundant data processing units (11, 12, 13). The inventive method comes from a generic computer program module which contains program instructions with parameterized program variables, where

a value for a parameter k is determined with 1≦k≦n, and

a kth redundant computer program module is produced by automatically replacing the parameterized program variables with nonparameterized program variables in accordance with the value of k.

### TECHNICAL FIELD

The invention relates to the field of programming control devices. It relates to a method for producing redundant computer program modules as per the precharacterizing clause of patent claim 1, and to computer program products used in the method.

### PRIOR ART

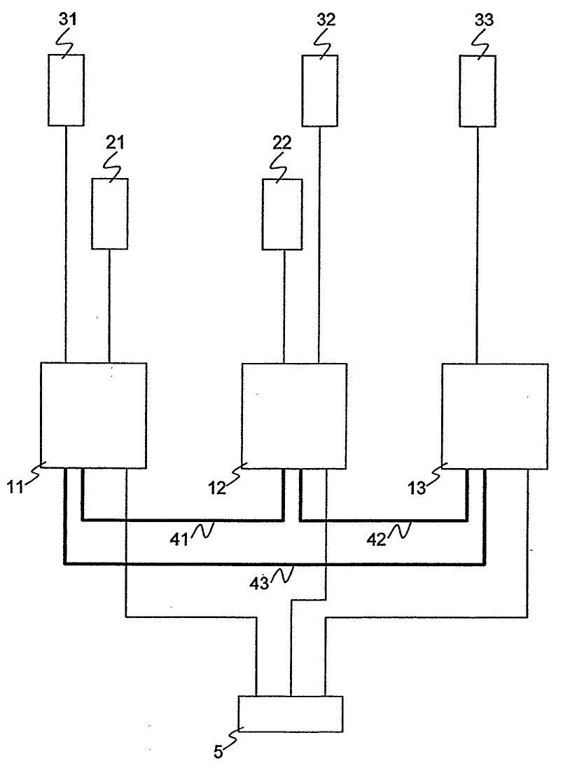

Redundant control devices and systems are used in applications having high demands in terms of security or availability. Data processing units and/or sensors they contain are produced with n-tuple redundancy, generally with dual or triple redundancy. FIG. 1 shows, schematically, a known structure for a redundant control system containing triple redundant data processing units 11, 12, 13, dual redundant first sensors 21, 22 and triple redundant second sensors 31, 32, 33. The two first sensors fundamentally measure the same physical quantity for an installation, for example a temperature, a pressure, a mass flow, etc. The same applies for the three second sensors. Sensor values are transmitted via a “measurement chain” to one or more redundant data processing units or control computers in a known manner. The measurement chain typically digitizes, transmits and scales measured values and may form discrete values for an amplitude of the measured values. Discrepancies between redundant measured values for a physical quantity indicate malfunctions in sensors and are ascertained by comparison of the measured values in the data processing units 11, 12, 13. Program modules running in the data processing units 11, 12, 13 provide control, regulation and protection functions which ensure operation of the installation. The data processing units 11, 12, 13 control hardware units 5. Hardware units 5 are actuators or protective devices driving a plurality of actuators. Actuators are motors or valves, for example. Actuators or protective devices are either produced with redundancy or are driven by “two-out-of-three” logic. This means that a control command is executed only if at least two of three redundant data processing units 11, 12, 13 produce the same control command. A check on control commands on the basis of the “two-out-of-three” logic takes place, by way of example, in a protective device or in the redundant data processing units 11, 12, 13 themselves by virtue of the latter interchanging the appropriate control commands among one another via communication links 41, 42, 43.

The program modules running in the data processing units 11, 12, 13 are redundant in the sense that they perform the same functions and operations in parallel with one another and fundamentally at the same time, and, when the control system is working correctly, receive matching sensor values and produce matching control commands. However, the redundant program modules differ in terms of references or program variables which relate to sensor signals, signals of adjacent data processing units or to control signals.

On the basis of the prior art, the redundant program modules are respectively assigned to a redundant data processing unit 11, 12, 13 and are manually created and maintained in appropriate separate versions. Thus, for example, three program modules are created with a similar structure, but with different references to measured value inputs and with data processing units having different hardware addresses. This makes consistent programming and modification of redundant program modules complex and susceptible to error.

### DESCRIPTION OF THE INVENTION

It is therefore an object of the invention to provide a method and a computer program product for producing redundant computer program modules of the type mentioned in the introduction which eliminate the aforementioned drawbacks.

This object is achieved by a method and a computer program product for producing redundant computer program modules having the features of patent claims 1 and 5, and by a computer program product for representing a generic computer program module having the features of patent claim 6.

The inventive method comes from a generic computer program module which contains program instructions having parameterized program variables, where

a value for a parameter k is determined with 1≦k≦n, and

a kth redundant computer program module is produced by automatically replacing the parameterized program variables with nonparameterized program variables in accordance with the value of k.

This makes it possible for only a single generic computer program to have to be created and maintained. The redundant computer program modules are produced automatically as required, which means that consistency of the redundant computer program modules is automatically ensured. In the case of a triple redundant system, this reduces the programming complexity to one third.

A computer program product for producing redundant computer program modules based on the invention can be loaded into an internal memory in a digital data processing means, possibly after compilation or translation, and has computer program code means which, when loaded and executed in a data processing unit, prompt the data processing unit to read a generic computer program module and to produce a redundant computer program module. The first computer program product preferably has a computer-readable medium with a computer program stored on it for carrying out the method based on the invention.

A computer program product for representing a generic computer program module based on the invention can be loaded into an internal memory in a digital data processing means and has computer program code means which represent parameterized program variables which can automatically be replaced with nonparameterized program variables in accordance with a parameter for the purpose of producing at least one of a plurality of redundant computer program modules.

Other preferred embodiments can be found in the dependent patent claims.

### BRIEF DESCRIPTION OF THE DRAWINGS

The invention is explained in more detail below with reference to preferred exemplary embodiments and to the appended drawings. The single FIGURE shows, schematically, a known structure for a redundant control system. The reference numerals used in the drawing and their meanings are summarized in the list of reference numerals.

### WAYS OF IMPLEMENTING THE INVENTION

In the structure described in the introduction for a control system as shown in FIG. 1, a first data processing unit 11 executes a first redundant computer program module, the second data processing unit 12 executes a second redundant computer program module, and the third data processing unit 13 executes a third redundant computer program module. For the sake of brevity, “redundant computer program modules” are referred to below as “modules”.

In terms of triple redundant functions, the three modules have essentially the same functionality, but in so doing process and produce different program variables. In this context, program variables are variables in the conventional sense and also references to measured values, communication signals and/or control commands or control values. By way of example, it will be assumed that it is possible to address measured values from a group of second sensors 31, 32, 33 using program variables named

P_myPump12 for a measured value from a first second sensor 31,

P_myPump23 for a measured value from a second second sensor 32,

P_myPump34 for a measured value from a third second sensor 33.

It is further assumed that a particular value calculated redundantly in each of the three modules is interchanged between the modules using the communication links 41, 42, 43 for control purposes. To this end, the value needs to be assigned to a program variable in a transmitting module and needs to be read from a program variable in a receiving module. The communication links are therefore configured, as is known, such that a value which is calculated or measured in a first module or an associated data processing unit and which is assigned to a first program variable is transmitted through the communication link to a second data processing unit, where it is processed further as the value of a second program variable.

Depending on which module is the transmitting module or the receiving module, the relevant program variables have different names. By way of example, a particular first value, calculated redundantly in a plurality of modules, is referred to

in the first module by the program variable CPU1_Value25,

in the second module by the program variable CPU2_Value25, and

in the third module by the program variable CPU3_Value25,

and, in the first module,

the appropriate value of the second module is referred to by the program variable CPU2_CPU1_Value25, and

the appropriate value of the third module is referred to by the program variable CPU3_CPU1_Value25.

Similarly, values of the first or third module are referred to in the second module by CPU1_CPU2_Value25 or CPU3_CPU2_Value25, and values of the first or second module are referred to in the third module by CPU1_CPU3_Value25 or CPU2_CPU3_Value25.

It is assumed that each of the modules has a program section in which the first value, as determined in the module itself, is compared with the corresponding values from the other modules. In the first module this program section thus refers to program variables CPU1_Value25, CPU2_CPU1_Value25 and CPU3_CPU1_Value25, in the second module a redundant program section refers to

CPU2_Value25, CPU1_CPU2_Value25 and CPU3_CPU2_Value25, and

in the third module a redundant program section refers to

CPU3_Value25, CPU1_CPU3_Value25 and CPU2_CPU3_Value 25.

Programming different versions using such varied program variables is susceptible to error. The automated production of different program versions for the redundant data processing units 11, 12, 13 eliminates corresponding programming errors.

According to the invention, program variables in a generic computer program module are represented in parameterized form. This means that such parameterized program variables are expressed by parameters or are defined by parameters. In accordance with one or more parameters, a parameterized program variable is used to form a concrete or nonparameterized program variable in a module. Nonparameterized program variables in different modules which have come from the same parameterized program variable generally relate to different quantities. By way of example, a nonparameterized program variable relates to a concrete sensor signal, a concrete control signal for an actuator or a concrete communication signal for another data processing unit. In this context “concrete” means that the quantity relates to a particular physically present unit, for example to a first sensor or to a second data processing unit. In contrast to this, a parameterized program variable relates, according to context, to different physical units, these units generally being redundant with respect to one another.

The generic computer program module expresses a shared functionality in redundant computer program modules or modules.

For the examples below, the parameterization is defined using the syntax below. However, any other syntactic and semantic conventions relating to syntax definition are possible which likewise implement the inventive idea.

References to parameters are enclosed by angle brackets ‘<’ and ‘>’. For the sake of brevity below, unless specified otherwise, the term “parameters” means the parameters for the parameterization of program variables within the context of the invention, as opposed to “parameters” for subroutine or function calls, as used in higher-level programming languages. Indexed data fields (arrays) are denoted using square brackets ‘[’ and ‘]’.

The notation

‘:=’ denotes an assignment operator assigning a value to a variable,

‘=’ denotes a logical equality operator,

‘#’ denotes a logical inequality operator,

‘&’ denotes an operator for producing rows of character strings,

‘+’ an addition operator,

‘*’ a multiplication operator,

where the operators are put in order of increasing precedence, that is to say that multiplication is performed before addition, for example.

All other characters denote character strings or numbers. The operators imply automatic conversion of data types for their operands. By way of example,

var1:=pre & 10+2

means that, first, 10 plus 2 is calculated and the result is joined as a character string to the character string “pre”, so that the program variable var1 receives the character string ‘pre12’ as a value.

In the expression

var2:=(<var1>=1)+1,

the effect of the angle brackets is that the value of the program variable var1 is evaluated, and not the character string ‘var1’. If this value is equal to the number 1 or is a character string which can be interpreted as the number 1, the expression in round brackets adopts the value 1, so that var2 receives the value 2. Otherwise, the expression in round brackets adopts the value 0, and var2 receives the value 1.

When parameterizing the program variables of a module, auxiliary variables which are used as parameters for other variables are preferably used. It is assumed that a parameter k where 1≦k≦3 indicates which module of three redundant computer program modules needs to be generated. By way of example, the following auxiliary variables or auxiliary parameters are then determined:

CPU_This:=k

CPU_Low:=(<CPU_This>=1)+1

CPU_High:=(<CPU_This>#3)+2

In the two bottom examples, the expressions to the right of the assignment operator are parameterized expressions, with a parameter CPU_This. When evaluating the expressions, the parameter is replaced with a value for the parameter. For the possible values of k, corresponding values of CPU_This, CPU_Low and CPU_High are obtained on the basis of the following table:

| k | 1 | 2 | 3 |
|---|---|---|---|
| CPU_This | 1 | 2 | 3 |
| CPU_Low | 2 | 1 | 1 |
| CPU_High | 3 | 3 | 2 |

Program variables parameterized in accordance with the invention, which denote measured values, are expressed as follows, for example:

P_measurement:=P_mypump & 10*<CPU_This>+<CPU_This>+1

In this case, the expression to the right of the assignment operator is a parameterized program variable. For a value 1 of the parameter CPU_This, this parameterized program variable is replaced with a nonparameterized program variable P_myPump12.

If the processing of the modules on the data processing units 11, 12, 13 supports evaluation of fields of parameters, measured values in the data processing units are selectively referred to by, for example,

P_measurement:=P_myPump[<CPU_This>],

where values of the parameter field P_mypump have been predefined as character string constants:

P_myPump[1]:=P_mypump12

P_myPump[2]:=P_myPump23

P_myPump[3]:=P_myPump34

For the first module with k =1 the value of the program variable P_measurement becomes P_myPump12, for the second module with k=2 the value of P measurement becomes P_myPump23, etc. The effect of this when the modules are executed on their associated data processing units 11, 12, 13 is that each module accesses a different, associated redundant sensor.

Supporting the evaluation of fields of parameters also makes it possible to parameterize program variables which are not, as shown above, named on the basis of a numbering convention. By way of example, prescribed names such as

P_mypump_Top,

P_myPump_Middle,

P_myPump_Bottom

are parameterized in the following way by assignment to elements of an array:

P_myPump[1]:=P_myPump_Top

P-myPump[2]:=P_myPump_Middle

P_myPmp[3]:=P_myPump_Bottom

Program variables parameterized according to the invention, which are interchanged via the communication links 41, 42, 43, are expressed as follows, for example:

from_Low:=CPU<CPU_Low>_CPU<CPU_This>_Value25

from_High:=CPU<CPU_High>_CPU<CPU_This>_Value25

to_Low_High:=CPU<CPU_This>_Value25

For the first module, these three parameterized program variables are replaced with the nonparameterized program variables below

CPU2_CPU1_Value25,

CPU3_CPU_Value25 and

CPU1_Value25.

A generic computer program module with program variables parameterized according to the invention preferably has a first program section, in which program variables, referred to below as intermediate variables, as described above are assigned a value expressed in parameterized form. Such intermediate variables are thus P_measurement, from_Low, from_High, to_Low_High. In further program sections, the intermediate variables are used for programming the regulation, control or protection functions of the control system. Programming is carried out in text form or in a mixed text/graphics form, as is known generally from “function plan languages”. The program excerpt below shows part of a generic computer program module by way of example. A first section is executed only once and, in line with the invention, results in determination of the nonparameterized program variables. A second program section is executed cyclically during regulation or control. Comments are enclosed by “(*” and “*)”.

(* evaluation only upon the first execution*)
If FirstScan( ) Then

(* initialize CPU parameters *)
CPU_This

:= PromptForInput(“Enter the CPU number:”,

| Integer) | |
|---|---|
| CPU_Low | := (<CPU_This> = 1)+1 |
| CPU_High: | := (<CPU_This>#3)+2 |

(* initialize hook-up parameters *)

| | |
|---|---|
| Hookup_for_1 | := <CPU_This>=3 |
| Hookup_for_2 | := <CPU_This>#1 |
| Hookup_for_3 | := 1 |

| (* initialize communication parameters *) | |
|---|---|
| from_Low := CPU<CPU_Low>_CPU<CPU_This>_Value25 | |
| : | |
| : | |
| (* initialize calculated parameters *) | |
| P_measurement:= P_myPump & 10 * <CPU_This> + | |
| <CPU_This> + 1 | |
| : | |
| : | |
| (* initialize hook-up parameters *) | |
| Hookup_of_P_measurement | := <Hookup_for_3> |

| Hookup_of_myPump | := <Hookup_for_2> |
|---|---|
| Hookup_of_Speed | := <Hookup_for_3> |
| (* initialize array parameters *) | |
| P_myPump [1] | := P_myPump_Top |
| P_myPump [2] | := P_myPump_Middle |
| P_myPump [3] | := P_myPump_Bottom |

End if

(* cyclically executed regulation *)

If Hookup_of_P_measurement = 1 Then

(* process P_measurement as connected measurement

*)
Else

(* process P_measurement as measurement not connected

directly *)
End if

In principle, it is also possible to use the program variables in the whole program, in particular in the cyclically executed program section, in parameterized form without using intermediate variables.

In one preferred variant of the invention, a degree of redundancy for sensors or actuators can be prescribed and evaluated as a parameter. When a module is executed, two or three measured values are compared with one another or averaged in accordance with a degree of redundancy of a sensor, for example. To this end, program variables which can be used to address sensors need to obey prescribed conventions, so that a reference to a sensor, that is to say a program variable which is assigned a sensor value, can be produced automatically. The same applies for actuators and communication links.

In another preferred variant of the invention, parameters are set regarding which data processing unit evaluates values from particular sensors on the basis of the degree of redundancy of the sensors. By way of example, in a triple redundant system, values from sensors which, for reasons of cost, are implemented only with dual redundancy, are always evaluated by the second and third data processing units 12, 13. Sensors provided only once are connected to the third data processing unit 13.

Corresponding auxiliary parameters are

Hookup_for_{—}1:=<CPU_This>=3

Hookup_for_{—}2:=<CPU_This>#1

Hookup_for_{—}3:=1

For each group of redundant sensors or actuators, a corresponding program variable is defined which indicates the number of connected sensors or actuators:

Hookup_of_T_H20:=<Hookup_for_{—}1>

Hookup_of_mypump:=<Hookup_for_{—}2>

Hookup_of_Speed:=<Hookup_for_{—}3>

Thus, these program variables are given the following values for the respective kth module

| k | 1 | 2 | 3 |
|---|---|---|---|
| Hookup_of_T_H20 | 0 | 0 | 1 |
| Hookup_of_myPump | 0 | 1 | 1 |
| Hookup_of_Speed | 1 | 1 | 1 |

This means that, on the basis of Hookup_of_T_H20, a particular water temperature measurement section is connected to the first data processing unit, two particular redundant pumps are respectively connected to the first and second data processing units, and three particular redundant speed sensors are respectively connected to one of the three data processing units. In this context, “connected” means that the sensor is physically connected to this data processing unit or to the appropriate control device.

In each module, evaluation of these program variables can thus be used to match the program execution to whether a particular sensor or actuator is actually connected, and whether coordination with values or results from one or two other modules is possibly required.

If, by way of example, the ambient temperature is available only in the form of a simple sensor and is physically connected to the third data processing unit 13, this is indicated to the computer program module using the parameter assignment

Hookup_of_T_Amb:=<CH_This>=3

On the basis of this variable, the evaluation can now take place in the various data processing units, as shown in the code example above.

The third data processing unit 13 reads the ambient temperature from the physical connection to the connected sensor in this case, performs the calculations associated with the ambient temperature and communicates the results of the calculations. In addition, the data processing unit 13 communicates the ambient temperature to the first and second data processing units 11 and 12.

By contrast, the first and second data processing units 11 and 12 read the ambient temperature from the third data processing unit 13, since the sensor is not connected directly to the first and second data processing units 11 and 12. They also perform the calculations associated with the ambient temperature and communicate the results of the calculations.

In the inventive method, the parameterized program variables of a generic computer program module are automatically replaced with nonparameterized or concrete program variables in accordance with the parameter k. Methods for evaluating parameterized expressions are implemented in existing compilers, precompilers, interpreters, etc., and are known generally. When programming a computer program for carrying out the inventive method, it is thus possible to use known evaluation methods.

In a first preferred variant of the invention, the inventive method is carried out repeatedly n times “offline” for various values of k. The generic computer program module is read by a conversion program based on the invention, and n modules are produced and are written to one or more storage media. These stored modules are loaded onto the data processing units 11, 12, 13. A kth module is thus loaded onto an associated kth data processing unit. To this end, a plurality of different variants of modules are individually transmitted to the respective control devices or data processing units and are loaded onto them. Depending on the type of control system, redundant computer program modules are compiled before or after loading or are converted in a similar way.

In a second preferred variant of the invention, the inventive method is carried out when the generic computer program module is loaded onto a data processing unit 11, 12, 13 in the control device or is carried out when the generic computer program module is executed by an interpreter running on the data processing unit 11, 12, 13. In this context, in the generic computer program module, before or during loading, either only the parameter k, which identifies the concrete data processing unit, is adjusted manually or the generic computer program module uses a request to a user or a hardware identification for the data processing unit 11, 12, 13 itself to ascertain on which data processing unit it is located and to which value of k this corresponds. In this variant, only one program variant, namely the generic one, is transmitted.

List of Reference Numerals

11 First data processing unit

12 Second data processing unit

13 Third data processing unit

21,22 First sensors

31,32,33 Second sensors

41,42,43 Communication links

5 Actuator or protective device

1. A method for producing one of n redundant computer program modules for programming one of n redundant data processing units (11, 12, 13) in a control system, where n≧2 and each of the redundant computer program modules is provided for execution on a respectively associated data processing unit (11, 12, 13), characterized
in that the method comes from a generic computer program module which has program instructions containing parameterized program variables,
in that a value for a parameter k is determined with 1≦k≦n, and
in that a kth redundant computer program module is produced by automatically replacing the parameterized program variables with nonparametrized program variables in accordance with the value of k.

2. The method as claimed in claim 1, characterized in that the production of a kth redundant computer program module is repeated n times for k=1, 2, . . . n.

3. The method as claimed in claim 1, characterized in that the method is carried out when the generic computer program module is loaded into the control device.

4. The method as claimed in claim 1, characterized in that the redundant computer program module produced is loaded into a data processing unit (11, 12, 13) in a kth control device from a total of n control devices.

5. A computer program product for producing one of n redundant computer program modules for programming one of n redundant data processing units (11, 12, 13) in a control system, where n≧2 and each of the redundant computer program modules is provided for execution on a respectively associated data processing unit (11, 12, 13), which computer program product can be loaded into an internal memory in a digital data processing means and has computer program code means which, when loaded and executed in a data processing unit, prompt the data processing unit to carry out the method having the following steps:
a generic computer program module containing program instructions with parameterized program variables is read,
a value for a parameter k is determined with 1≦k≦n, and
a kth redundant computer program module is produced by automatically replacing the parameterized program variables with nonparameterized program variables in accordance with the value of k.

6. A computer program product for representing a generic computer program module which can be loaded into an internal memory in a digital data processing means and has computer program code means which represent parameterized program variables which can be automatically replaced with nonparameterized program variables in accordance with a parameter for the purpose of producing one of n redundant computer program modules, where n≧2 and the n redundant computer program modules are provided for programming n redundant data processing units (11, 12, 13) in a control system, each of the redundant computer program modules being provided for execution on a respectively associated data processing unit (11, 12, 13).
